(19) United States
(12) Patent Application Publication
(10) Pub. No.: US 2026/0314982 A1
(43) Pub. Date: Oct. 15, 2026

(54) NONADHESIVE CARDIAC MONITOR

(71) Applicant: APEX MONITORING SYSTEMS LLC, Salt Lake City, UT (US)

(72) Inventors: Calvin Coates, Sandy, UT (US); Cambri Jessop, Salt Lake City, UT (US); Izabella Echols, Hurricane, UT (US); Parker Mason, Santaquin, UT (US); Adam Kotter, Salt Lake City, UT (US); Zachary Wade, Salt Lake City, UT (US)

(21) Appl. No.: 19/645,528

(22) Filed: Apr. 13, 2026

Related U.S. Application Data
(60) Provisional application No. 63/788,202, filed on Apr. 14, 2025.

(51) Int. Cl. A61B 5/353; A61B 5/00; A61B 5/256; A61B 5/27; A61B 5/282; A61B 5/352; A61B 5/355

(52) U.S. Cl. CPC A61B 5/353; A61B 5/0006; A61B 5/256; A61B 5/27; A61B 5/282; A61B 5/352; A61B 5/355; A61B 5/6831; A61B 5/746; A61B 2503/045; A61B 2560/0214; A61B 2560/0468

(57) ABSTRACT

A cardiac monitoring device is disclosed. The device includes at least two sensing elements to continuously acquire cardiac signals, a wireless communication module, a processor, and memory. The memory stores a machine learning model (MLM) and instructions that cause the device to classify data segments of the cardiac signals into one of a normal classification, an abnormal classification, or a corrupted classification. For data segments classified as abnormal, the device identifies a waveform characteristic that contributed to the abnormal classification. The device transmits, using the wireless communication module, the abnormal data segments and identified waveform characteristic to a processing device, and causes the processing device or a remote computing device to generate an alert to a clinician comprising the abnormal classification and identified waveform characteristic.

### CROSS-REFERENCE TO RELATED APPLICATIONS

This application claims priority to U.S. Application No. 63/788,202, titled Nonadhesive Cardiac Arrhythmia Monitor, filed Apr. 14, 2025, which is hereby incorporated by reference in its entirety.

### TECHNICAL FIELD

Embodiments of the present disclosure relate to medical monitoring, and in particular to methods, devices, and systems for ambulatory electrocardiogram (ECG or EKG) monitoring. The methods, devices, and systems are suitable for extended cardiac monitoring of subjects, including neonates and pediatric patients with sensitive skin.

### BACKGROUND

Certain cardiac diseases or disorders can be difficult or impossible to detect in a subject without monitoring the subject during extended ECG monitoring periods. However, extended ECG monitoring periods can be uncomfortable for subjects being monitored due to the equipment used to conduct the ECG monitoring periods.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates an example embodiment of an ambulatory cardiac monitoring (ACM) device being worn by a subject, according to certain embodiments.

FIG. 2 illustrates an ACM system including a network that facilitates communication between one or more ACM devices and one or more remote computing devices, according to certain embodiments.

FIG. 3A illustrates a strap assembly of an ACM device including one or more shoulder straps, according to certain embodiments.

FIG. 3B illustrates a strap assembly of an ACM device including hook and eye fasteners, according to certain embodiments.

FIG. 4A illustrates a perspective view of a backside of a strap assembly including a fabric pocket for an electronics housing unit, according to certain embodiments.

FIG. 4B illustrates a perspective view of an inside of a strap assembly including sensing elements, according to certain embodiments.

FIG. 5 illustrates a perspective view of an ACM device including a hook and loop strap, according to certain embodiments.

FIG. 6 illustrates a perspective view of an ACM device including a battery compartment and an ECG compartment, according to certain embodiments.

FIG. 7 illustrates a block diagram of a circuit board for an ACM device, according to certain embodiments.

FIG. 8 illustrates a graph showing an ECG signal being separated into typical ECG wave components for analysis, according to certain embodiments.

FIG. 9 illustrates a graph showing an ECG signal being segmented into a plurality of data segments and the data segments being classified by a machine learning model, according to certain embodiments.

FIG. 10 illustrates a block diagram of an ACM system including an ACM device, a server device, and a clinician device, according to certain embodiments.

FIG. 11 illustrates a flow chart depicting a method for acquiring and processing cardiac signals from a subject with an ACM device, according to certain embodiments.

FIG. 12 illustrates a flow chart depicting a method for receiving and processing cardiac signals from an ACM device, according to certain embodiments.

FIG. 13 illustrates a flow chart depicting a method for receiving and reviewing cardiac signals and alerts from an ACM device or server device, according to certain embodiments.

### DETAILED DESCRIPTION OF EMBODIMENTS

Embodiments described herein are related to devices, systems, and methods for non-adhesive cardiac monitors.

Attempts have been made to create ambulatory ECG monitoring devices, such as Holter monitors, to make extended ECG monitoring periods more comfortable. However, these devices rely on adhesive electrodes and bulky, rigid form factors that can irritate a patient’s skin and cause discomfort to the patient trying to perform daily activities. Current ECG monitoring devices are challenging for use in neonates or patients with sensitive skin or other skin disorders due to the adhesives used on the electrodes causing irritation or injury. For example, neonatal skin is thin, sensitive, and prone to injury or irritation and the adhesives used on current electrodes can cause irritation to injury to the neonate’s skin when the electrodes are removed or adjusted. Additionally, conventional ECG monitoring devices are typically designed for adult sized subjects and are therefore poorly suited for neonates' size, immunity, and other physiological characteristics.

Conventional ECG monitoring devices are frequently limited to short monitoring durations. For example, electrodes may need to be replaced frequently (e.g., after twenty-four hour periods) due to electrode adhesives losing efficacy after being readjusted or coming in contact with a subject’s sweat. Conventional ECG monitoring devices also require substantial clinical resources for setup, operation, and data retrieval, requiring a nurse or medical practitioner to place the electrodes in the proper location on the subject, connect the electrodes to the device, and readjust or troubleshoot the electrodes if the connection is lost. Moreover, conventional ECG monitoring devices are not optimized for safe and comfortable long-term wear by subjects in a home, ambulatory, or outpatient environment.

The integration of an ECG monitoring system into an ambulatory or wearable platform for subjects includes several challenges. These challenges can include providing reliable cardiac signal acquisition in ambulatory (mobile and electronically noisy) environments, enabling extended data collection over multiple days or weeks without external power sources, and facilitating remote data retrieval and transmission for clinical analysis without repeated clinical visits. Other challenges include the accommodation of sensitive and fragile skin, such as ensuring secure but non-irritating attachment to neonates with a variety of body sizes. Aspects and embodiments of the present disclosure address these issues and more by providing ambulatory cardiac monitoring systems and devices that enable extended, comfortable, and safe monitoring for subjects in an outpatient environment while maintaining accurate data and reliable transmission to clinical providers.

The present disclosure is directed to ambulatory cardiac monitoring (ACM) devices, systems, and methods for extended ECG monitoring while in in-home or outpatient settings. According to certain embodiments, an ACM device is disclosed. The ACM device may include a strap assembly. The strap assembly may be used to secure the ACM device to a subject. The ACM device may also include at least two sensing elements. The at least two sensing elements may be ECG sensing elements. The at least two sensing elements may be positioned within the strap assembly to continuously acquire cardiac signals from a subject. For example, the at least two sensing elements may be positioned on an inside face of a strap of the strap assembly that contacts a subject's skin. The strap assembly may also be used to hold the at least two sensing elements flush against a subject's skin. The ACM device may include at least one electronics housing. The electronics housing may contain signal processing electronics. The electronics housing may also include a power source. In some embodiments, the electronics housing may include one or more wireless communication modules. In some embodiments, the electronics housing includes a processor. The processor may be a microprocessor. In certain embodiments, the electronics housing includes memory. The memory may store the cardiac signals acquired by the at least two sensing elements. In some embodiments, the memory stores a machine learning model (MLM) and instructions that, when executed by the processor, cause the ACM device to classify data segments of the cardiac signals into one of a normal classification, an abnormal classification, or a corrupted classification. For one or more data segments classified with the abnormal classification, the instructions may cause the ACM device to identify a waveform characteristic of the cardiac signals that contributed to the MLM assigning the abnormal classification. The memory may also store instructions that, when executed by the processor, cause the ACM device to transmit, using the wireless communication module, the one or more data segments classified with the abnormal classification and the identified waveform characteristic to a processing device, and cause at least one of the processing device or a remote computing device to generate an alert to at least one clinician, wherein the alert comprises at least the abnormal classification and the identified waveform characteristic for the one or more data segments.

The disclosed ACM devices, systems, and methods provide multiple advantages over existing cardiac monitors. For example, an ACM device or system may include conductive fabric electrodes that can acquire cardiac signals without requiring adhesive attachment to the subject's skin, which enables safe and comfortable long-term wear for patients with sensitive skin.

In some embodiments, an ACM device may support extended monitoring durations of four to twelve weeks per patient, which may facilitate detection of intermittent arrhythmias that shorter monitoring periods may miss. The ACM device may reduce dependence on clinic-based monitoring equipment by enabling outpatient or home-based cardiac monitoring. In certain embodiments, the ACM device may include a single-patient-use design that promotes safety and hygiene while allowing the strap assembly to be machine washed after removal of electronic components. The ACM device may incorporate machine learning classification that categorizes cardiac data segments as normal, abnormal, or corrupted, which may reduce cognitive burden on clinicians reviewing the collected data. In some embodiments, the machine learning model may identify waveform characteristics that contributed to an abnormal classification, such as irregular spacing between heartbeats, unexpected waveform segment durations, or atypical waveform peak amplitudes, thereby providing clinicians with actionable information without rendering a diagnosis. The ACM device may utilize a reduced number of sensing elements compared to traditional twelve-lead ECG systems while still enabling arrhythmia detection through the use of machine learning algorithms trained on cardiac signal data. In some embodiments, the strap assembly may be sized to accommodate neonatal patients having chest circumferences between approximately six inches and approximately fourteen and one-half inches, addressing a patient population that is underserved by conventional adult-sized cardiac monitors. The extended battery life of the ACM device may support multi-day continuous monitoring without requiring recharging. The ACM device may also provide simple, caregiver-friendly setup and maintenance, as well as reliable data acquisition and transmission for remote clinical evaluation, which may enable earlier detection of cardiac abnormalities and intervention before conditions worsen.

In the following detailed description, reference is made to the accompanying drawings, which form a part of this disclosure and illustrate specific exemplary embodiments. These are merely examples, and other embodiments may be utilized without departing from the scope of the present disclosure. Variations in mechanical configuration may be made as needed. Accordingly, this detailed description is not intended to be limiting.

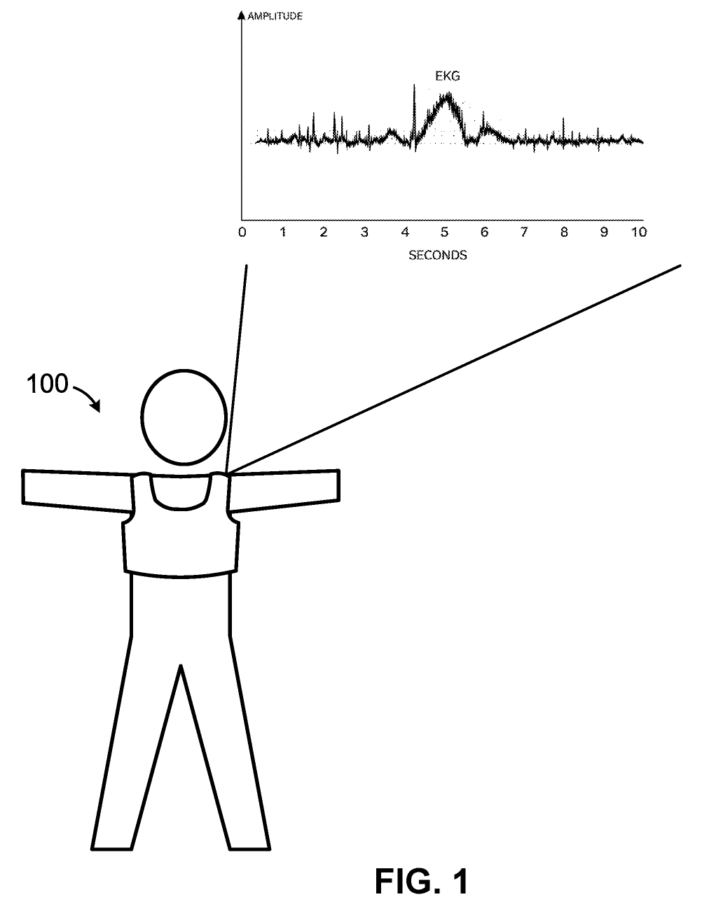

FIG. 1 illustrates an example embodiment of an ambulatory cardiac monitoring (ACM) device 100 being worn by a subject, according certain embodiments. ACM device 100 is shown positioned on the subject's body to acquire cardiac (or electrocardiogram (ECG)) signals from the subject. In the illustrated embodiment, ACM device 100 is depicted as a vest-style configuration; however, one of ordinary skill in the art will recognize that ACM device 100 may be implemented in various form factors without departing from the scope of the present disclosure. For example, in some embodiments, ACM device 100 may comprise a single band designed to wrap around a subject's chest without including shoulder straps. In other embodiments, ACM device 100 may include a chest strap in combination with one or more shoulder straps to provide additional stability during use.

ACM device 100 may be designed to acquire cardiac signals from a subject while the subject performs daily activities, including walking, sitting, sleeping, or other movements typical of home or outpatient environments. ACM device 100 may provide reliable cardiac signal acquisition in ambulatory environments, enabling extended data collection over multiple days or weeks without external power sources, and facilitating easy data retrieval and transmission for clinical analysis without repeated clinical visits. In certain embodiments, ACM device 100 and its components are sized to accommodate neonatal subjects or other patients with sensitive skin. In other embodiments, ACM device 100 may be sized to accommodate pediatric or adult subjects.

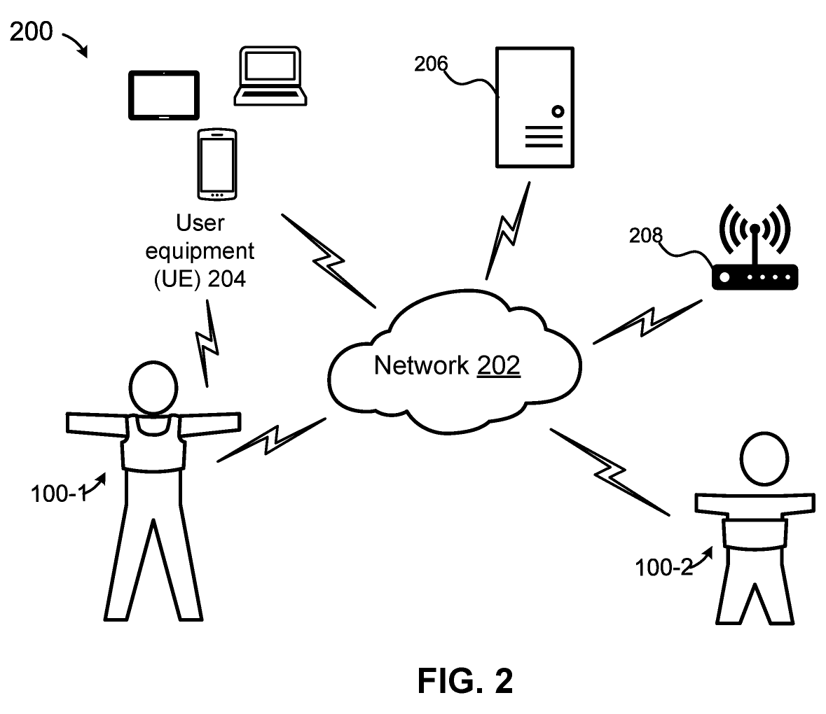

FIG. 2 illustrates an ACM system 200, according to certain embodiments. ACM system 200 may include a network 202 that facilitates communication between one or more ACM devices and one or more remote computing devices. Network 202 may support any suitable wireless communication method or protocol. For example, network 202 may implement one or more wireless communication protocols such as Wi-Fi, Bluetooth, Bluetooth Low Energy (BLE), cellular communication protocols (e.g., 3G, 4G, LTE, 5G), satellite communication protocols, IEEE communication protocols, Internet of Things (IoT) network protocols, Zigbee network protocols, another similar type of wireless communication protocol, or a combination thereof. In some embodiments, network 202 may support multiple wireless communication protocols simultaneously to provide flexibility in data transmission and device connectivity.

ACM system 200 may include one or more ACM devices configured to communicate with network 202. In the illustrated embodiment, ACM system 200 includes an ACM device 100-1 and an ACM device 100-2. ACM device 100-1 may be sized to accommodate an adult subject and include one or more shoulder straps, while ACM device 100-2 may be sized to accommodate a neonatal subject and only include a chest strap. However, one of ordinary skill in the art will recognize that ACM system 200 may include any number of ACM devices sized for various patient populations, including pediatric subjects, without departing from the scope of the present disclosure. In some embodiments, ACM device 100-2 may be sized to accommodate neonatal patients having chest circumferences between approximately six inches and approximately fourteen and one-half inches.

Network 202 may be designed to communicate with various wireless devices and computing systems. For example, network 202 may communicate with user equipment (UE) 204, such as smartphones, tablets, laptop computers, desktop computers, or other portable or stationary computing devices. UE 204 may be operated by a clinician, a caregiver, a medical provider, or the subject wearing the ACM device. In some embodiments, UE 204 may execute a software application that receives cardiac data from an ACM device, displays cardiac metrics to a user, or transmits instructions to an ACM device to control monitoring sessions.

Network 202 may also communicate with one or more server devices Server devices 206 may include a remote processing server, cloud-based storage systems, remote processing servers, clinical data management platforms, or the like. In some embodiments, server devices 206 are used for final signal processing and storage of transmitted data or cardiac signals received from ACM devices 100-1 and 100-2. Server devices 206 may store a machine learning model (MLM) and instructions that, when executed by one or more server processors, cause server devices 206 to receive cardiac signals from an ACM device, segment the received cardiac signals into a plurality of data segments, classify each data segment into one of a normal classification, an abnormal classification, or a corrupted classification, and for each data segment classified with the abnormal classification, identify a waveform characteristic of the data segment that contributed to the abnormal classification. Server devices 206 may generate an alert comprising the abnormal classification and the identified waveform characteristics for transmission to a clinician device.

Network 202 may further communicate with one or more routers 208 or other network infrastructure devices that route data packets between devices within ACM system 200. Routers 208 may include wireless access points, network switches, gateways, or other networking equipment.

ACM devices 100-1 and 100-2 may transmit ECG data through network 202 to any of the devices included in ACM system 200. For example, ACM devices 100-1 and 100-2 may transmit cardiac signals, processed cardiac data, cardiac metrics such as average heart rate and heart rate variability, or alerts to UE 204, server devices 206, or other remote computing devices. In some embodiments, the transmitted data is encrypted prior to transmission to protect patient privacy and comply with applicable data security requirements.

ACM devices 100-1 and 100-2 may also communicate directly with a processing device, such as UE 204, without routing data through intermediate network infrastructure. For example, ACM devices 100-1 and 100-2 may establish a direct Bluetooth or Bluetooth Low Energy connection with UE 204 to transmit cardiac data or receive control instructions. This direct communication capability may facilitate easy data retrieval and transmission for clinical analysis without repeated clinical visits and may enable caregiver-friendly setup and maintenance of the ACM devices.

In some embodiments, the one or more wireless communications modules of the ACM devices 100-1 and 100-2 may receive wireless signals from devices within the network 202. The received signals may include instructions transmitted by a medical provider's wireless device to cause an ACM device to start collecting cardiac signals at the beginning of a monitoring session, stop collecting cardiac signals at the end of a monitoring session, transmit previously collected cardiac data, calculate new cardiac data and transmit the new cardiac data, perform other similar operations, or a combination thereof.

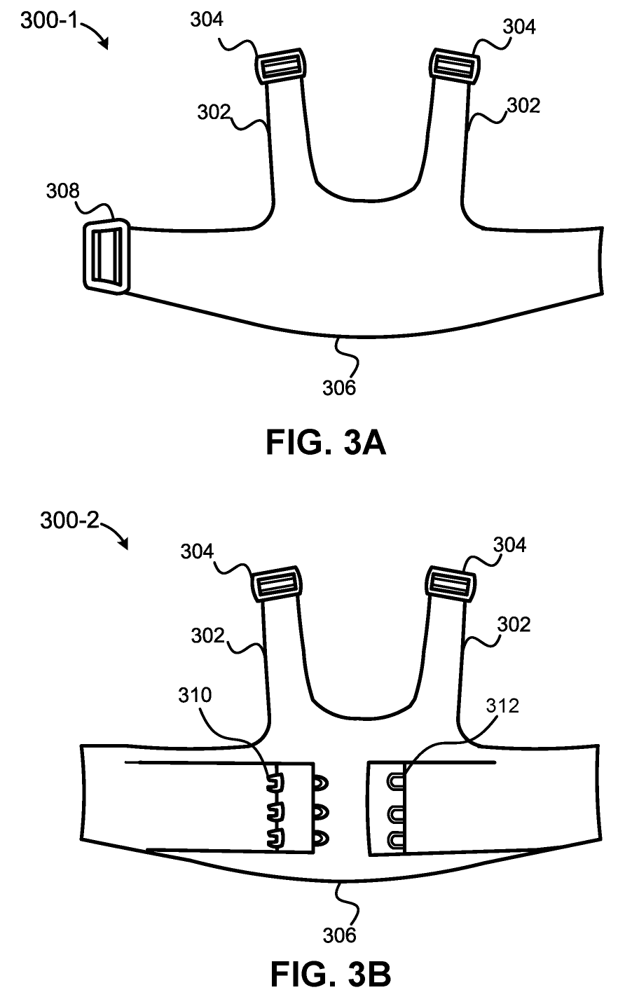

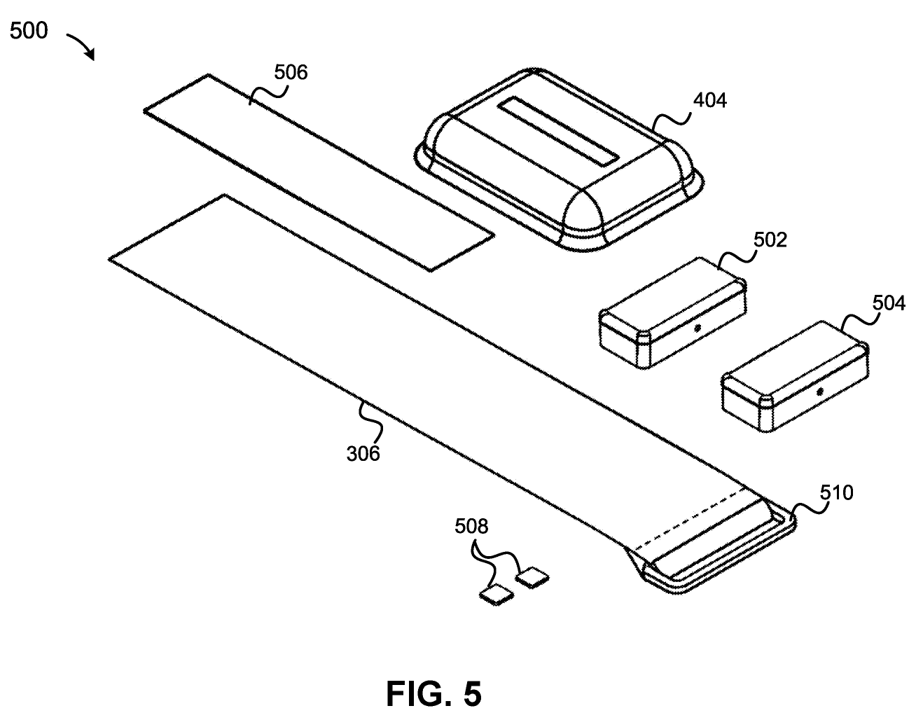

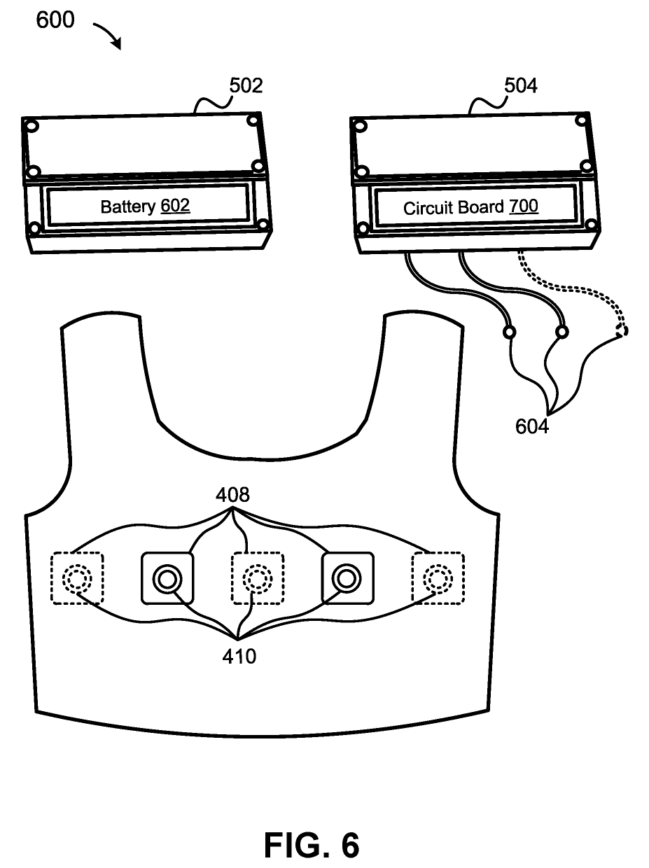

FIG. 3A illustrates a strap assembly 300-1 of an ACM device in accordance with one or more embodiments. Strap assembly 300-1 may be used with any of the ACM devices described herein, such as ACM device 100 depicted in FIG. 1, ACM device 100-1 and ACM device 100-2 depicted in FIG. 2, ACM device 500 depicted in FIG. 5, or ACM device 600 depicted in FIG. 6. Strap assembly 300-1 may be used to secure an ACM device to a subject and provide stability to the ACM device while the ACM device is worn by the subject.

Strap assembly 300-1 may include one or more straps. In some embodiments, the one or more straps are adjustable straps that accommodate a range of body sizes and allow a secure fit without adhesives or rigid attachments that can compromise skin integrity. The one or more straps may be made from an elastic material. Elastic materials may exhibit properties that allow the straps to stretch and conform to a subject's body contours while applying compression to hold sensing elements flush against the subject's skin. For example, elastic materials may have a degree of elongation that permits the straps to expand while a subject puts on or removes the ACM device and then return to their original dimensions to maintain consistent contact pressure during use. The elastic properties may also allow the straps to accommodate natural body movements, such as breathing, without losing contact with the subject's skin or creating discomfort. In some embodiments, the elastic material comprises a nylon spandex blend, which is a hypoallergenic material that is breathable, creating a comfortable environment for subjects with sensitive skin, such as neonates. However, one of ordinary skill in the art will recognize that the straps may be constructed from a different material without departing from the scope of the present disclosure. For example, the straps may be made from medical-grade silicone, bamboo fabric, Tencel, cotton, neoprene, polyester blends, polypropylene, or the like.

The one or more straps may include a chest strap 306. Chest strap 306 may be designed to wrap around the torso of a subject. In some embodiments, strap assembly 300-1 includes chest strap 306 and one or more shoulder straps 302. The one or more shoulder straps 302 may be designed to wrap over the shoulders of a subject to provide additional stability to the ACM device during ambulatory use. The one or more shoulder straps 302 may be sewn directly onto chest strap 306 to form an integrated strap assembly. In other embodiments, the one or more shoulder straps 302 may be removably attached to chest strap 306, allowing strap assembly 300-1 to be configured as a vest-style configuration or as a single band configuration without shoulder straps depending on the needs of the subject or the clinical application. In some embodiments, chest strap 306 and the one or more shoulder straps 302 may be integrally formed as a unitary component. Chest strap 306 and the one or more shoulder straps 302 may be made from a single piece of material, thereby eliminating seams between the straps.

The one or more shoulder straps 302 may be adjusted using tri-glide fasteners (or buckles) 304. Tri-glide fasteners 304 may allow a caregiver or the subject to adjust the length of shoulder straps 302 to achieve a secure and comfortable fit. Other adjustable fasteners may also be used in place of tri-glide fasteners 304 without departing from the scope of the present disclosure. For example, the one or more shoulder straps 302 may be adjusted using a hook-and-loop attachment (e.g., Velcro), button fasteners, snap fasteners, pins, clips, clamps, buckles, or other types of adjustable fasteners.

In some embodiments, chest strap 306 is adjustable by using a tri-glide fastener 308 attached to one end of chest strap 306. Chest strap 306 may be adjusted by feeding the other end of chest strap 306 through tri-glide fastener 308, pulling chest strap 306 to a desired tightness, and allowing tri-glide fastener 308 to hold chest strap 306 in place. While tri-glide fasteners are depicted, one of ordinary skill in the art will recognize that a different kind of attachment may be used, such as hook and loop attachments, buttons, snaps, pins, clamps, or the like, without departing from the scope of the present disclosure.

The straps of strap assembly 300-1 may be made of materials that are machine washable (after removing any embedded electronics or sensing elements), meaning they will not deteriorate or be damaged while being washed in common laundering detergents in a household washing machine. In some embodiments, the straps are all made of the same material. In certain embodiments, the one or more straps are made from different materials. Strap assembly 300-1 and its components may be sized to fit a neonatal subject having a chest circumference between approximately six inches and approximately fourteen and one-half inches. In other embodiments, strap assembly 300-1 may be sized to accommodate pediatric or adult subjects.

FIG. 3B illustrates a strap assembly 300-2 of an ACM device, according to certain embodiments. Strap assembly 300-2 may be used with any of the ACM devices described herein, such as ACM device 100 depicted in FIG. 1, ACM device 100-1 and ACM device 100-2 depicted in FIG. 2, ACM device 500 depicted in FIG. 5, or ACM device 600 depicted in FIG. 6. Strap assembly 300-2 may be used to secure an ACM device to a subject and provide stability to the ACM device while the ACM device is worn by the subject.

Strap assembly 300-2 may include one or more straps. In some embodiments, the one or more straps are adjustable straps, meaning the straps can be adjusted to conform to subjects of different sizes. For example, the adjustable straps may accommodate a range of body sizes from neonatal subjects to adult subjects, allowing a secure fit without adhesives or rigid attachments that can compromise skin integrity. The adjustability of the straps may enable a single strap assembly design to be manufactured in multiple sizes or may allow a single strap assembly to accommodate growth or changes in a subject's body size during an extended monitoring period.

The one or more straps may be made from an elastic material, which may exhibit properties similar to those described with reference to strap assembly 300-1. In some embodiments, the elastic material comprises a nylon spandex blend, which has properties that make the material hypoallergenic and breathable, creating a comfortable environment for subjects with sensitive skin, such as neonates. However, one of ordinary skill in the art will recognize that the straps may be constructed from a different material without departing from the scope of the present disclosure. For example, the straps may be made from medical-grade silicone, bamboo fabric, Tencel, cotton, neoprene, polyester blends, polypropylene, or the like.

The one or more straps may include a chest strap 306. Chest strap 306 may wrap around the torso of a subject. In some embodiments, strap assembly 300-2 includes chest strap 306 and one or more shoulder straps 302. The one or more shoulder straps 302 may wrap over the shoulders of a subject to provide additional stability to the ACM device during ambulatory use. The one or more shoulder straps 302 may be sewn directly onto chest strap 306 to form an integrated strap assembly. In other embodiments, the one or more shoulder straps 302 may be removably attached to chest strap 306, allowing strap assembly 300-2 to be configured as a vest-style configuration or as a single band configuration without shoulder straps depending on the needs of the subject or the clinical application.

The one or more shoulder straps 302 may be adjusted using tri-glide fasteners 304. Tri-glide fasteners 304 may allow a caregiver or the subject to adjust the length of shoulder straps 302 to achieve a secure and comfortable fit. Other adjustable fasteners may also be used in place of tri-glide fasteners 304 without departing from the scope of the present disclosure. For example, the one or more shoulder straps 302 may be adjusted using hook and loop attachments (e.g., Velcro), button fasteners, snap fasteners, pins, clips, clamps, buckles, or other types of adjustable fasteners.

In some embodiments, chest strap 306 is adjustable by using hook fasteners 310 that can insert into eye fasteners 312. Hook fasteners 310 may be attached to one end of chest strap 306 and eye fasteners 312 may be attached to the other end of chest strap 306. The hook and eye fastener arrangement may allow a caregiver or the subject to secure chest strap 306 at a desired tightness by selecting which eye fastener 312 to engage with hook fastener 310. In some embodiments, multiple eye fasteners 312 are positioned at different locations along chest strap 306 to provide a range of adjustment positions. While hook and eye fasteners are depicted, one of ordinary skill in the art will recognize that a different kind of attachment may be used, such as hook and loop attachments, buttons, snaps, pins, clamps, tri-glide fasteners, or the like, without departing from the scope of the present disclosure.

The straps of strap assembly 300-2 may be made of materials that are machine washable (after removing any embedded electronics or sensing elements), meaning they will not deteriorate or be damaged while being washed in common laundering detergents in a household washing machine. In some embodiments, the straps are all made of the same material. In certain embodiments, the one or more straps are made from different materials. Strap assembly 300-2 and its components may be sized to fit a neonatal subject having a chest circumference between approximately six inches and approximately fourteen and one-half inches. In other embodiments, strap assembly 300-2 may be sized to accommodate pediatric or adult subjects.

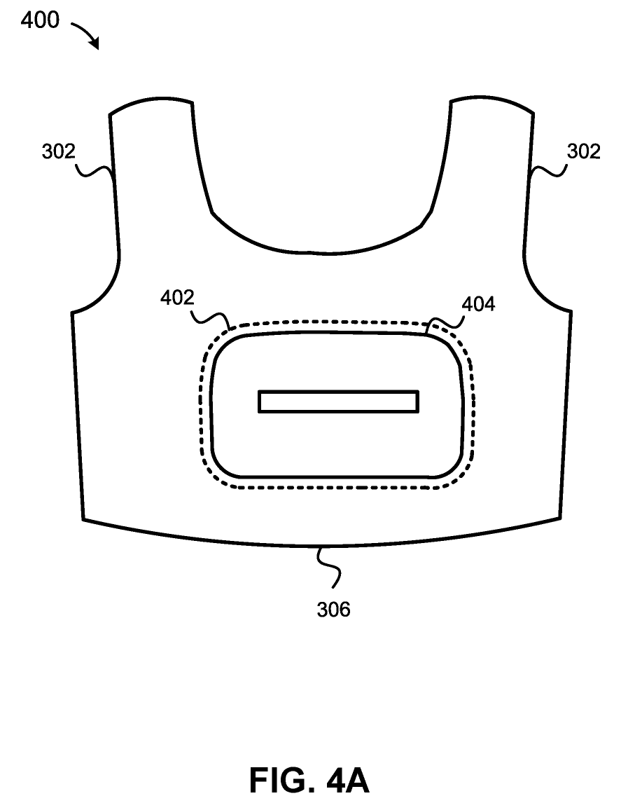

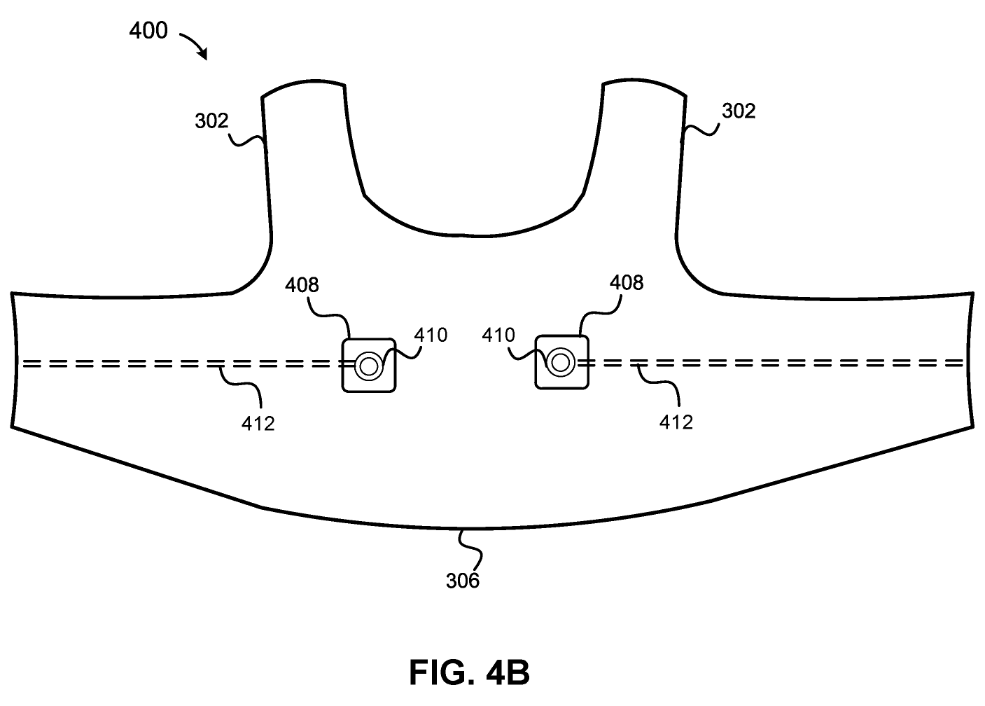

FIG. 4A illustrates a perspective view of a backside of a strap assembly 400 in accordance with one or more embodiments. Strap assembly 400 may be used with any of the ACM devices described herein, such as ACM device 100 depicted in FIG. 1, ACM device 100-1 and ACM device 100-2 depicted in FIG. 2, ACM device 500 depicted in FIG. 5, or ACM device 600 depicted in FIG. 6. Strap assembly 400 may be used to secure an ACM device to a subject and provide stability to the ACM device while the ACM device is worn by the subject.

Strap assembly 400 may include a fabric pocket 402 integrated into strap assembly 400. In some embodiments, fabric pocket 402 is sewn into chest strap 306. Fabric pocket 402 may be sized to contain an electronics housing unit 404. Electronics housing unit 404 may or may be an electronics housing designed to house signal processing electronics, a power source, a wireless communication module, a processor, and memory as described herein.

Fabric pocket 402 may be constructed from the same elastic material as chest strap 306. For example, fabric pocket 402 may comprise a nylon spandex blend, which has properties that make the material hypoallergenic and breathable, creating a comfortable environment for subjects with sensitive skin, such as neonates. However, one of ordinary skill in the art will recognize that fabric pocket 402 may be constructed from a different material without departing from the scope of the present disclosure. For example, fabric pocket 402 may be made from medical-grade silicone, bamboo fabric, Tencel, cotton, neoprene, polyester blends, polypropylene, or the like.

Fabric pocket 402 may be designed to hold electronics housing unit 404 securely against a subject's body during use. In some embodiments, the elastic properties of fabric pocket 402 allow fabric pocket 402 to conform to the contours of electronics housing unit 404 and apply gentle compression to maintain electronics housing unit 404 in a fixed position relative to the subject's body. By holding electronics housing unit 404 against the subject's body, fabric pocket 402 may reduce the number of noise artifacts recorded by the ACM device by preventing additional movement and vibration of electronics housing unit 404 when the subject moves. reduce noise artifacts caused by movement of electronics housing unit 404 when the subject moves. For example, fabric pocket 402 may minimize motion artifacts in the cardiac signals acquired by the sensing elements by dampening oscillations or displacements of electronics housing unit 404 that could otherwise occur during ambulatory activities such as walking, sitting, sleeping, or other movements typical of home or outpatient environments.

In some embodiments, fabric pocket 402 includes an opening or closure mechanism to allow insertion and removal of electronics housing unit 404. The closure mechanism may comprise a hook and loop attachment, a zipper, a snap fastener, a button, or other fastening means that allows a caregiver or the subject to access electronics housing unit 404 for charging, replacement, or maintenance while maintaining secure retention of electronics housing unit 404 during normal use. Fabric pocket 402 may be made of materials that are machine washable after removal of electronics housing unit 404, meaning fabric pocket 402 will not deteriorate or be damaged while being washed in common laundering detergents in a household washing machine.

FIG. 4B illustrates a perspective view of an inside of a strap assembly 400 in accordance with one or more embodiments. Strap assembly 400 may be used with any of the ACM devices described herein, such as ACM device 100 depicted in FIG. 1, ACM device 100-1 and ACM device 100-2 depicted in FIG. 2, ACM device 500 depicted in FIG. 5, or ACM device 600 depicted in FIG. 6.

Strap assembly 400 may include one or more sensing elements 408 positioned on an inside surface of chest strap 306. The inside surface may be the surface of chest strap 306 that contacts a subject's skin when strap assembly 400 is worn by the subject. In some embodiments, sensing elements 408 are sewn into the inside surface of chest strap 306. In other embodiments, sensing elements 408 may be attached to the inside surface using adhesive, heat bonding, ultrasonic welding, or other similar attachment methods without departing from the scope of the present disclosure.

Sensing elements 408 may comprise electrodes, such as conductive fabric electrodes. Conductive fabric electrodes may be made from a conductive material that can conduct bio-electrical signals from a subject's body. For example, the conductive material may comprise silver-plated fibers, stainless steel fibers, carbon-infused fibers, conductive polymers, or other materials capable of conducting bioelectrical signals. The use of conductive fabric electrodes may enable noninvasive cardiac signal acquisition without the use of adhesive materials, which may reduce skin irritation or injury for subjects with sensitive skin, such as neonates. In some embodiments, sensing elements 408 comprise at least two sensing elements that continuously acquire cardiac signals from a subject. In certain embodiments, sensing elements 408 comprise three conductive fabric electrodes arranged to collectively acquire single-lead ECG data.

Sensing elements 408 may include contacts 410 that electrically couple sensing elements 408 to one or more ECG lead wires. Contacts 410 may be conductive elements, such as snaps, rivets, conductive pads, or other electrical connectors, that provide a reliable electrical connection between the conductive fabric of sensing elements 408 and the ECG lead wires. Electrical signals conducted by sensing elements 408 from the subject's body may pass through contacts 410 and into the ECG lead wires, which transmit the electrical signals to signal processing electronics within an electronics housing for signal conditioning and conversion into digital ECG data.

Strap assembly 400 may include ECG lead wires 412 that electrically couple contacts 410 to an electronics housing, such as electronics housing unit 404. In some embodiments, ECG lead wires 412 are sewn into the fabric of chest strap 306. Integrating ECG lead wires 412 into the fabric of chest strap 306 may protect the wires from damage during use and may reduce the likelihood of the wires becoming tangled or snagged during ambulatory activities. In other embodiments, ECG lead wires 412 connect to contacts 410 externally without being sewn into chest strap 306, which may facilitate replacement or repair of ECG lead wires 412.

ECG lead wires 412 may be shielded wiring. Shielded wiring may reduce noise in the cardiac signals captured by sensing elements 408, such as noise produced by motion artifacts, electromagnetic interference, or other signal noise sources. The shielding may comprise a conductive layer surrounding the signal-carrying conductor of each ECG lead wire 412, which may attenuate external electromagnetic interference and improve signal quality.

Sensing elements 408 may be embedded in strap assembly 400 in a configuration that is arranged to collect single-lead ECG data, which may be sufficient for standard arrhythmia detection. However, one of ordinary skill in the art will recognize that sensing elements 408 may be positioned in other configurations to collect multi-lead ECG data without departing from the scope of the present disclosure. The positioning of sensing elements 408 on the inside surface of chest strap 306 may allow strap assembly 400 to hold sensing elements 408 flush against a subject's skin, which may improve signal quality and reduce motion artifacts during ambulatory use.

FIG. 5 illustrates a perspective view of an ACM device 500 in accordance with one or more embodiments. ACM device 500 may be used in any of the ACM systems described herein, such as ACM system 200 depicted in FIG. 2. ACM device 500 may acquire cardiac signals while a subject performs daily activities, including walking, sitting, sleeping, or other movements typical of home or outpatient environments.

ACM device 500 may include an electronics housing unit 404. Electronics housing unit 404 may be a modular housing that allows for removal and replacement of electronic components. In some embodiments, electronics housing unit 404 is designed to be removably enclosed within a housing compartment or fabric pocket integrated into a strap assembly, as described with reference to FIGS. 3A, 3B, and 4A.

Electronics housing unit 404 may include a battery compartment 502 and an ECG compartment 504. Battery compartment 502 may house a power source configured to provide electrical power to the electronic components of ACM device 500. In some embodiments, battery compartment 502 contains a battery with a capacity of 1200 mAH that can power ACM device 500 for a period of at least 72 hours before needing to be recharged. However, one of ordinary skill in the art will recognize that batteries of different capacities may be used without departing from the scope of the present disclosure. Battery compartment 502 may be configured to allow a caregiver or the subject to replace or recharge the battery without replacing the entire electronics housing unit 404.

ECG compartment 504 may house signal processing electronics, a processor, memory, and one or more wireless communication modules. The processor may be a microprocessor, a microcontroller, or the like. In some embodiments, the processor may be a low-power microcontroller unit. The processor may be designed to execute instructions stored on a computer readable medium, that, when executed, cause ACM device 500 to store cardiac signals obtained from a subject. The instructions, when executed, may also cause the processor to calculate real-time peak detection of the cardiac signals using thresholding and derivative-based algorithms. Examples of such algorithms may include derivative-based methods that detect the steep slopes of the QRS complex, moving average methods with adaptive thresholds, slope sum functions that enhance QRS complexes by summing positive slopes over a window, or wavelet transform methods that identify characteristic scales of QRS complexes. These algorithms may be used to identify the R-wave by detecting the largest amplitude peak, and then locate the P-wave, Q-wave, S-wave, and T-wave based on their temporal and amplitude relationships to the identified R-wave. The instructions may also cause the processor to calculate cardiac metrics such as a subject's average heart rate and the variability of the subject's heart rate.

ACM device 500 may include a hook and loop strap 506 that secures a chest strap 306 to a subject's torso. Hook and loop strap 506 may be fed through a loop 510 and secured at a desired tightness level to hold ACM device 500 in place on the subject. While a hook and loop attachment is depicted, one of ordinary skill in the art will recognize that a different kind of attachment may be used, such as buttons, snaps, pins, clamps, or the like, without departing from the scope of the present disclosure. Hook and loop strap 506 may allow ACM device 500 to be adjustable to accommodate a range of body sizes and allow a secure fit without adhesives or rigid attachments that can compromise skin integrity. In some embodiments, ACM device 500 may be sized to accommodate neonatal patients having chest circumferences between approximately six inches and approximately fourteen and one-half inches. In other embodiments, ACM device 500 may be sized to accommodate pediatric subjects having chest circumferences between approximately fourteen inches and approximately thirty-two inches. In still other embodiments, ACM device 500 may be sized to accommodate adult subjects having chest circumferences between approximately thirty inches and approximately fifty inches. In some embodiments, the memory stores a machine learning model (MLM) and instructions that, when executed by the processor, cause ACM device 500 to classify data segments of the cardiac signals into one of a normal classification, an abnormal classification, or a corrupted classification. The one or more wireless communication modules may implement one or more wireless communication protocols such as Wi-Fi, Bluetooth, Bluetooth Low Energy (BLE), or the like.

ACM device 500 may include at least two sensing elements 508 that continuously acquire cardiac signals from a subject. In some embodiments, sensing elements 508 may comprise electrodes, such as conductive fabric electrodes. Conductive fabric electrodes may be made from a conductive material that can conduct electrical signals from a subject's body. For example, the conductive material may comprise silver-plated fibers, stainless steel fibers, carbon-infused fibers, conductive polymers, or other materials capable of conducting bioelectrical signals. In certain embodiments, sensing elements 508 comprise three conductive fabric electrodes arranged to collectively acquire single-lead electrocardiogram (ECG) data. The use of conductive fabric electrodes may enable noninvasive cardiac signal acquisition without the use of adhesive materials, which may reduce skin irritation or injury for subjects with sensitive skin, such as neonates.

Sensing elements 508 may be positioned on an inside surface of chest strap 306 that contacts a subject's skin when ACM device 500 is worn by the subject. Sensing elements 508 may be embedded in the strap assembly in a configuration that is arranged to collect single-lead ECG data, which may be sufficient for standard arrhythmia detection. However, one of ordinary skill in the art will recognize that sensing elements 508 may be positioned in other configurations to collect multi-lead ECG data without departing from the scope of the present disclosure. Sensing elements 508 may be electrically coupled to ECG compartment 504 via ECG lead wires, which may be shielded wiring to reduce noise in the cardiac signals captured by sensing elements 508.

FIG. 6 illustrates a perspective view of an ACM device 600 in accordance with one or more embodiments. ACM device 600 may be used in any of the ACM systems described herein, such as ACM system 200 depicted in FIG. 2. ACM device 600 may be designed to acquire cardiac signals while a subject performs daily activities, including walking, sitting, sleeping, or other movements typical of home or outpatient environments.

ACM device 600 may include a battery compartment 502. Battery compartment 502 may house one or more batteries 602 and/or one or more battery packs that provide electrical power to the electronic components of ACM device 600. Battery 602 may be any suitable type of battery, including a primary (non-rechargeable) battery, a rechargeable battery, a lithium-ion battery, a lithium-polymer battery, a nickel-metal hydride battery, a similar type of electrochemical cell capable of storing and delivering electrical energy, or a combination thereof. In some embodiments, battery 602 has a capacity of approximately 1200 mAH that can power ACM device 600 for a period of at least 72 hours before needing to be recharged. However, one of ordinary skill in the art will recognize that batteries of different capacities may be used without departing from the scope of the present disclosure.

In some cases, battery compartment 502 may include a sufficient number of batteries 602 or battery packs to allow ACM device 600 to record cardiac signals during an extended monitoring period. For example, battery compartment 502 may support monitoring durations of four to twelve weeks per patient, which may facilitate detection of intermittent arrhythmias that shorter monitoring periods may miss. Battery compartment 502 may allow a caregiver or the subject to replace or recharge battery 602 without replacing the entire electronics housing unit.

ACM device 600 may also include an ECG compartment 504. ECG compartment 504 may be electrically coupled to and powered by battery 602 housed in battery compartment 502. In some embodiments, ECG compartment 504 includes the circuitry and communication components required to record and transmit cardiac signals or ECG data obtained from a subject. ECG compartment 504 may house signal processing electronics, a processor, memory, and one or more wireless communication modules. The processor may be a microprocessor, a microcontroller, or the like. In some embodiments, the processor may be a low-power microcontroller unit. The processor may execute instructions stored on a computer readable medium, that, when executed, cause ACM device 600 to store cardiac signals obtained from a subject. The instructions may also cause the processor to calculate cardiac metrics such as a subject's average heart rate and the variability of the subject's heart rate.

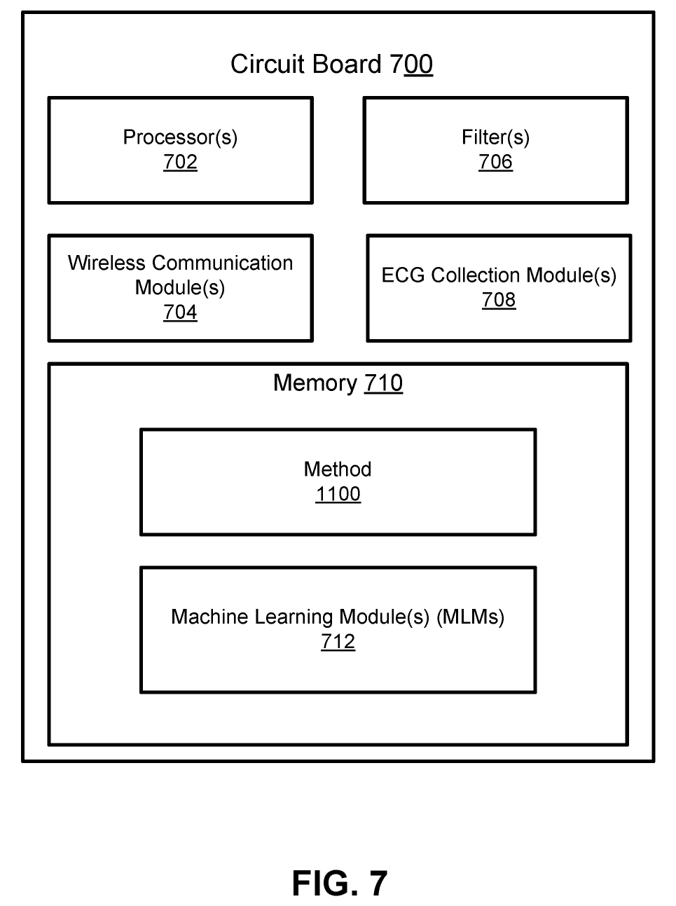

ECG compartment 504 may include a circuit board, such as circuit board 700 described with reference to FIG. 7. The circuit board may include analog front-end circuitry for signal conditioning, digital processing components, and wireless communication hardware.

ECG compartment 504 may also include one or more leads 604. Leads 604 may be wires that transmit electrical signals from sensing elements to the signal processing electronics within ECG compartment 504. In some embodiments, leads 604 comprise shielded wiring. Shielded wiring may reduce noise in the cardiac signals captured by ACM device 600, such as noise produced by motion artifacts, electromagnetic interference, or other signal noise sources. The shielding may comprise a conductive layer surrounding the signal-carrying conductor of each lead 604, which may attenuate external electromagnetic interference and improve signal quality.

ACM device 600 may include at least two sensing elements 408 that continuously acquire cardiac signals from a subject. In some embodiments, ACM device 600 includes additional sensing elements 408 to provide a total of between three and twelve sensing elements. Sensing elements 408 may comprise electrodes, such as conductive fabric electrodes. Conductive fabric electrodes may be made from a conductive material that can conduct electrical signals from a subject's body. For example, the conductive material may comprise silver-plated fibers, stainless steel fibers, carbon-infused fibers, conductive polymers, or other materials capable of conducting bioelectrical signals. The use of conductive fabric electrodes may enable noninvasive cardiac signal acquisition without the use of adhesive materials, which may reduce skin irritation or injury for subjects with sensitive skin, such as neonates.

Sensing elements 408 may be embedded in a strap assembly in a configuration that is arranged to collect single-lead ECG data, which may be sufficient for standard arrhythmia detection. However, one of ordinary skill in the art will recognize that sensing elements 408 may be positioned in other configurations to collect multi-lead ECG data without departing from the scope of the present disclosure. For example, configurations with additional sensing elements may enable acquisition of three-lead, five-lead, or twelve-lead ECG data depending on the clinical requirements.

FIG. 7 illustrates a block diagram of a circuit board 700 in accordance with one or more embodiments. Circuit board 700 may be included in any of the ACM devices described herein, such as ACM device 100 depicted in FIG. 1, ACM device 100-1 and ACM device 100-2 depicted in FIG. 2, ACM device 500 depicted in FIG. 5, or ACM device 600 depicted in FIG. 6. Circuit board 700 may be a printed circuit board (PCB), an application-specific integrated circuit (ASIC), a field-programmable gate array (FPGA), a digital signal processor (DSP), a system-on-chip (SoC), or another similar type of circuit board or integrated circuit assembly.

Circuit board 700 may include one or more processors 702. Processor 702 may be a microprocessor, a microcontroller, a central processing unit (CPU), a low-power microcontroller unit (MCU), a reduced instruction set computing (RISC) processor, an ARM-based processor, or the like. In some embodiments, processor 702 is a low-power microcontroller unit designed to minimize power consumption during extended monitoring periods. Processor 702 may execute instructions stored in memory to perform various signal processing and data management operations.

Circuit board 700 may also include one or more wireless communication modules 704. Wireless communication module 704 may be a Wi-Fi transceiver, a Bluetooth transceiver, a Bluetooth Low Energy (BLE) module, a cellular modem, a near-field communication (NFC) module, a Zigbee transceiver, an IEEE 802.15.4 compliant radio, or other wireless communication hardware capable of transmitting and receiving data wirelessly. Wireless communication module 704 may be used to communicate with remote computing devices in a wireless network, such as network 202 described with reference to FIG. 2. Remote computing devices may include processing devices such as smartphones, tablets, laptop computers, or other user equipment (UE), server devices, cloud-based storage systems, clinical data management platforms, or other similar types of computing devices that can communicate in wireless communication networks.

Wireless communication module 704 may transmit signals to remote computing devices. The signals may include alerts, cardiac signals, EKG data, waveform characteristics, cardiac metrics such as average heart rate and heart rate variability, data segments classified as normal, abnormal, or corrupted, or other similar signals. In some embodiments, wireless communication module 704 transmits, to a processing device, one or more data segments classified with an abnormal classification and an identified waveform characteristic that contributed to the abnormal classification. Wireless communication module 704 may also transmit signals that cause at least one of the processing device or a remote computing device to generate an alert to at least one clinician, wherein the alert comprises at least the abnormal classification and the identified waveform characteristic for the one or more data segments.

Circuit board 700 may also include one or more filters 706. Filters 706 may include analog filters, digital filters, or a combination thereof that filter noise and other artifacts from collected cardiac signals. In some embodiments, filters 706 include a notch filter that attenuates power line interference at 50 Hz or 60 Hz, a bandpass filter that passes frequencies within a range typical of cardiac signals while attenuating frequencies outside that range, a low-pass filter that removes high-frequency noise, a high-pass filter that removes baseline wander, or an adaptive filter that dynamically adjusts filtering parameters based on signal characteristics. Filters 706 may reduce noise produced by motion artifacts, electromagnetic interference from surrounding electronic devices, power lines, lighting fixtures, or other signal noise sources.

Circuit board 700 may also include one or more ECG collection modules 708. ECG collection module 708 may be electrically coupled to leads 604 and filter 706. ECG collection module 708 may be a circuit designed to receive bioelectric signals from leads connected to a subject and condition and digitize the bioelectric signals into ECG data suitable for processing and storage. In some embodiments, ECG collection module 708 includes analog front-end circuitry for signal conditioning, amplification, and analog-to-digital conversion. The analog front-end circuitry may include an instrumentation amplifier for differential amplification of weak bioelectric signals while rejecting common-mode noise. The analog front-end circuitry may also include analog filters, such as high-pass filters for baseline wander removal and low-pass filters for anti-aliasing prior to digitization. In some embodiments, the analog front-end circuitry includes a programmable gain amplifier (PGA) to scale the conditioned signal to an appropriate amplitude range before digitization. ECG collection module 708 may include an analog-to-digital converter (ADC) to convert the conditioned analog signal into digital samples. In certain embodiments, ECG collection module 708 includes digital signal processing circuitry for further filtering, decimation, or preliminary processing of the digitized data before storage in memory 710 or transmission via wireless communication module 704. ECG collection module 708 may acquire single-lead electrocardiogram data, which may be sufficient for standard arrhythmia detection. However, one of ordinary skill in the art will recognize that ECG collection module 708 may acquire multi-lead ECG data, such as three-lead, five-lead, or twelve-lead ECG data, without departing from the scope of the present disclosure.

Circuit board 700 may also include memory 710. Memory 710 may be random access memory (RAM), read-only memory (ROM), flash memory, electrically erasable programmable read-only memory (EEPROM), static random access memory (SRAM), dynamic random access memory (DRAM), non-volatile memory, solid-state storage, or other computer-readable storage media. Memory 710 may store instructions that, when executed by processor 702, cause an ACM device to perform actions specified in blocks of method 1100, which is described in more detail below. Memory 710 may also store cardiac signals acquired from a subject, processed cardiac data, cardiac metrics, and classification results.

MLM 712 may label peaks within the cardiac signals according to their relevance to the ECG waveform, such as identifying the R peak, the P peak, and the T peak. MLM 712 may use thresholding and derivative-based algorithms to perform peak detection. Examples of such algorithms may include derivative-based methods that detect the steep slopes of the QRS complex, moving average methods with adaptive thresholds, slope sum functions that enhance QRS complexes by summing positive slopes over a window, or wavelet transform methods that identify characteristic scales of QRS complexes. These algorithms may be used to identify the R-wave by detecting the largest amplitude peak, and then locate the P-wave, Q-wave, S-wave, and T-wave based on their temporal and amplitude relationships to the identified R-wave. MLM 712 may perform quantization of each aspect of the labeled peaks and then identify which combinations of quantized values are alertable. MLM 712 may be a neural network, a convolutional neural network (CNN), a recurrent neural network (RNN), a long short-term memory (LSTM) network, a support vector machine (SVM), a decision tree, a random forest, a gradient boosting model, or other machine learning architecture suitable for time-series classification tasks. MLM 712 may be a lightweight model with reduced computational complexity, enabling MLM 712 to be stored in on-device memory and executed by processor 702 without requiring cloud-based processing resources. In some embodiments, MLM 712 may have a model size of less than approximately 100 megabytes, or may comprise fewer than approximately 10 million parameters, enabling storage and execution on resource-constrained embedded systems. In some embodiments, the computational resources required by MLM 712 are measured in megabytes rather than gigabytes, enabling MLM 712 to be executed on circuit board 700 without requiring cloud-based processing.

MLM 712 may be trained with ECG data obtained using any of the ACM devices described herein, such as ACM device 100 depicted in FIG. 1, ACM device 100-1 and ACM device 100-2 depicted in FIG. 2, ACM device 500 depicted in FIG. 5, or ACM device 600 depicted in FIG. 6, to recognize patterns in ECG data obtained using the number of electrodes included in the respective ACM device. MLM 712 may be trained using publicly available ECG data, and may be further fine-tuned using data from a specific ACM device prototype to adapt to the specific characteristics of that device. MLM 712 may be used to classify data segments of cardiac signals processed by ECG collection module 708 into one of three categories: a normal classification, an abnormal classification, or a corrupted classification.

MLM 712 may be trained to flag potentially abnormal data segments that should be reviewed in more detail by a clinician to obtain a diagnosis, without the device itself rendering a diagnosis. MLM 712 may classify each segment of uploaded data as either normal, abnormal, or corrupted, where corrupted indicates too much noise, too many data artifacts, or a disconnected lead. For data segments classified as abnormal, MLM 712 may identify what features caused it to classify the segment as abnormal, such as irregular spacing between heartbeats, or a portion of the waveform that is longer or shorter than expected. MLM 712 may be trained using supervised learning, unsupervised learning, semi-supervised learning, reinforcement learning, or a combination thereof. In some embodiments, MLM 712 is trained using labeled ECG data that includes examples of normal cardiac rhythms, various arrhythmias, and corrupted signals to enable accurate classification across the three categories.

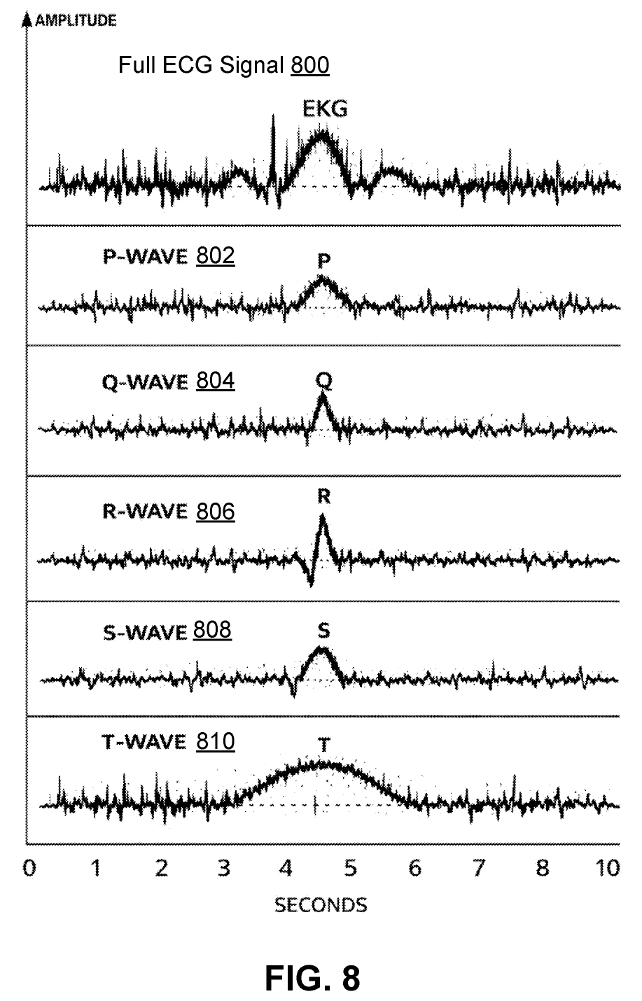

FIG. 8 illustrates a graph showing a full ECG signal 800 being separated into typical ECG wave components for analysis in accordance with one or more embodiments. Full ECG signal 800 may represent cardiac signals acquired by any of the ACM devices described herein, such as ACM device 100 depicted in FIG. 1, ACM device 100-1 and ACM device 100-2 depicted in FIG. 2, ACM device 500 depicted in FIG. 5, or ACM device 600 depicted in FIG. 6.

An ECG waveform for a single beat may be referred to as a PQRST complex, as it may include a P wave, a Q wave, an R wave, an S wave, and a T wave. As illustrated, full ECG signal 800 may be separated into a P-wave 802, a Q-wave 804, an R-wave 806, an S-wave 808, and a T-wave 810. In some embodiments, full ECG signal 800 may also include a U-wave, although this component may not be present in all ECG recordings.

The P wave appears at initiation of the beat and corresponds to activity in the atria, while the QRST complex follows the P wave and corresponds to ventricular activity. P-wave 802 may represent the electrical depolarization of the atria as the heart prepares to contract. In some embodiments, the characteristics of P-wave 802, such as its amplitude, duration, and morphology, may be analyzed to detect atrial abnormalities or irregular atrial rhythms.

Q-wave 804 may represent the initial phase of ventricular depolarization. Q-wave 804 may appear as a small downward deflection immediately preceding R-wave 806. In some embodiments, the presence, absence, or abnormal characteristics of Q-wave 804 may be indicative of certain cardiac conditions.

MLM 712 may uniquely identify each wave of an ECG waveform by first determining which wave comprises the largest amplitude, and labeling this wave as the R wave. R-wave 806 may represent the primary upward deflection of the QRS complex and may correspond to the main electrical activation of the ventricles. R-wave 806 may be a prominent peak in the ECG waveform and may be used as a reference point for identifying other waveform components. In some embodiments, MLM 712 described with reference to FIG. 7 may identify R-wave 806 by determining which peak comprises the largest amplitude within a cardiac cycle.

MLM 712 may label a wave immediately following the R wave as the S wave. S-wave 808 may represent the terminal phase of ventricular depolarization. S-wave 808 may appear as a downward deflection immediately following R-wave 806. Together, Q-wave 804, R-wave 806, and S-wave 808 form the QRS complex, which represents the electrical activation of the ventricles.

T-wave 810 represents the repolarization of the ventricles, which is the electrical recovery phase as the heart muscle recovers and prepares for the next cardiac cycle. In humans, it has been found that the T wave is a suitable interval for detecting alternans. As used herein, "alternans" refers to beat-to-beat variations in ECG waveform characteristics, particularly in the T-wave amplitude or morphology, that may indicate cardiac electrical instability. That is, variations in the T waves of alternating beats may be used to assess or evaluate a patient's cardiac electrical stability. In some embodiments, the characteristics of T-wave 810 may be analyzed to detect abnormalities in ventricular recovery.

The features of an ECG waveform which may be analyzed to diagnose an ECG comprise the amplitudes for each of the P, Q, R, S, T and U waves, as well as the time between one or more of the P, Q, R, S, T, and U waves, which may be referred to as intervals or segments. For example, the interval of time between initiation of the P wave and initiation of the QRS complex may be referred to as the PR interval, and may be used to diagnose the physiological condition of a heart. In another example, the duration of time between initiation of the Q wave and termination of the T wave, which may be referred to as the QT interval, may be used to diagnose the physiological condition of the heart.

Further diagnostic features of an ECG include a heart rate, which may be determined from the beat to beat interval (such as a Q-Q interval, a T-T interval, etc.) and the beat to beat variation in P, Q, R, S, and T amplitudes and/or intervals. In some embodiments, processor 702 described with reference to FIG. 7 may calculate cardiac metrics such as a subject's average heart rate and the variability of the subject's heart rate based on the intervals between successive R-waves 806.

MLM 712 described with reference to FIG. 7 may label peaks within the cardiac signals according to their relevance to the ECG waveform, such as identifying R-wave 806, P-wave 802, and T-wave 810. MLM 712 may perform quantization of each aspect of the labeled peaks and then identify which combinations of quantized values exceed predetermined thresholds or match patterns associated with potential cardiac abnormalities warranting clinician review, going beyond simple threshold-based detection. As used herein, "quantization" in this context refers to converting continuous waveform measurements, such as amplitude, duration, and timing relationships, into discrete categorical or numerical values suitable for analysis by the machine learning model. For example, MLM 712 may analyze the amplitude, duration, and timing relationships between P-wave 802, the QRS complex (comprising Q-wave 804, R-wave 806, and S-wave 808), and T-wave 810 to classify data segments as normal, abnormal, or corrupted.

In some embodiments, MLM 712 may identify waveform characteristics that contributed to an abnormal classification, such as irregular spacing between heartbeats (e.g., variations in the R-R interval), unexpected waveform segment durations (e.g., prolonged QT intervals or widened QRS complexes), or atypical waveform peak amplitudes (e.g., elevated or depressed ST segments, inverted T-waves, or abnormal P-wave morphology). By identifying these specific waveform characteristics, MLM 712 may provide clinicians with actionable information for further evaluation without rendering a diagnosis.

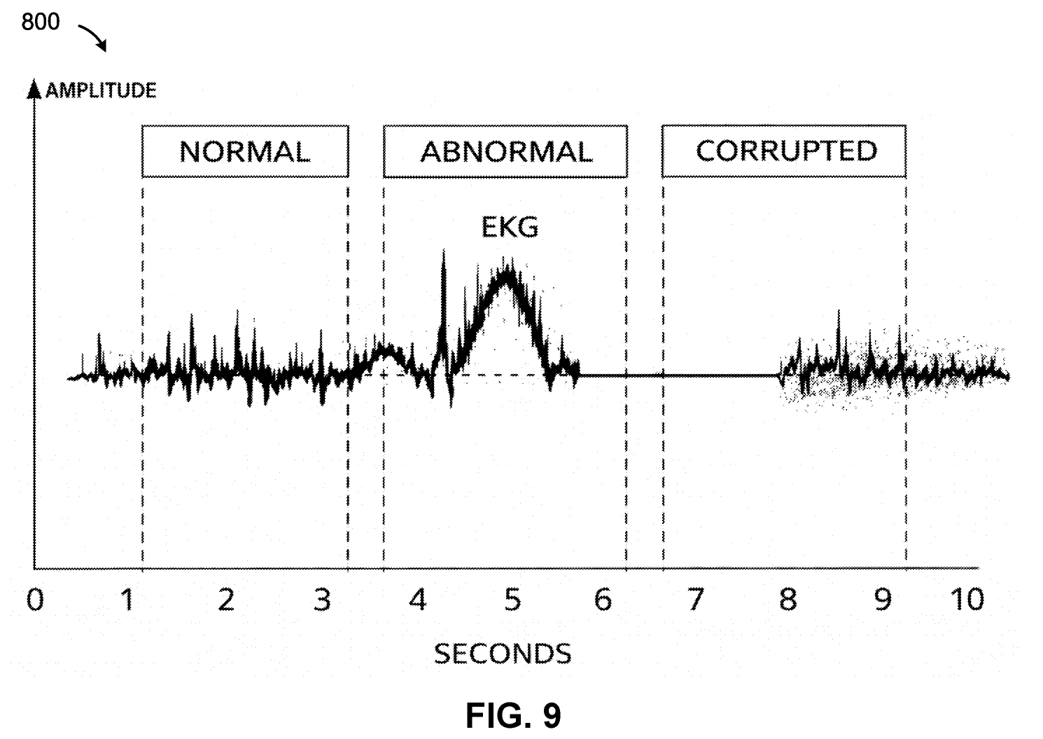

FIG. 9 illustrates a graph showing ECG signal 800 being segmented into a plurality of data segments and the data segments being classified by an MLM in accordance with one or more embodiments. The MLM, such as MLM 712 described with reference to FIG. 7, may analyze the wave components of ECG signal 800, including P-wave 802, Q-wave 804, R-wave 806, S-wave 808, and T-wave 810, to classify each data segment into one of three classifications: a normal classification, an abnormal classification, or a corrupted classification.

In some embodiments, the normal classification may be assigned to data segments where the MLM determines with a certainty level exceeding a predetermined threshold that the cardiac signals in the data segment exhibit characteristics consistent with healthy cardiac activity. For example, data segments classified as normal may exhibit regular spacing between heartbeats, waveform segment durations within expected ranges, and waveform peak amplitudes consistent with baseline cardiac function.

The abnormal classification may be assigned to data segments where the certainty level is below the predetermined threshold that the cardiac signals exhibit characteristics consistent with healthy cardiac activity. The abnormal classification may signal that a clinician should review these data segments in more detail for potential diagnosis. In some embodiments, the abnormal classification does not render a diagnosis but rather flags the data segment for further clinical evaluation. For data segments classified with the abnormal classification, the MLM may identify one or more waveform characteristics that contributed to the classification, such as irregular spacing between heartbeats (e.g., variations in the R-R interval), unexpected waveform segment durations (e.g., prolonged QT intervals or widened QRS complexes), or atypical waveform peak amplitudes (e.g., elevated or depressed ST segments, inverted T-waves, or abnormal P-wave morphology). By identifying these specific waveform characteristics, the MLM may provide clinicians with actionable information for further evaluation without rendering a diagnosis.

The corrupted classification may indicate that the cardiac signals acquired from the subject exhibit non-physiological characteristics. In some embodiments, non-physiological characteristics may include a flat line signal, high frequency noise exceeding a threshold power spectral density, one or more abrupt signal discontinuities indicative of faulty electrode connection, or excessive motion artifacts. Data segments classified as corrupted may be excluded from clinical analysis or flagged for review to determine whether the sensing elements require adjustment or replacement.

In some embodiments, the classification results, including data segments classified with the abnormal classification and the identified waveform characteristics that contributed to the abnormal classification, may be transmitted to a processing device or a remote server for clinician review. The MLM may generate an alert comprising the abnormal classification and the identified waveform characteristics for transmission to a clinician device, which may enable earlier detection of cardiac abnormalities and intervention before conditions worsen.

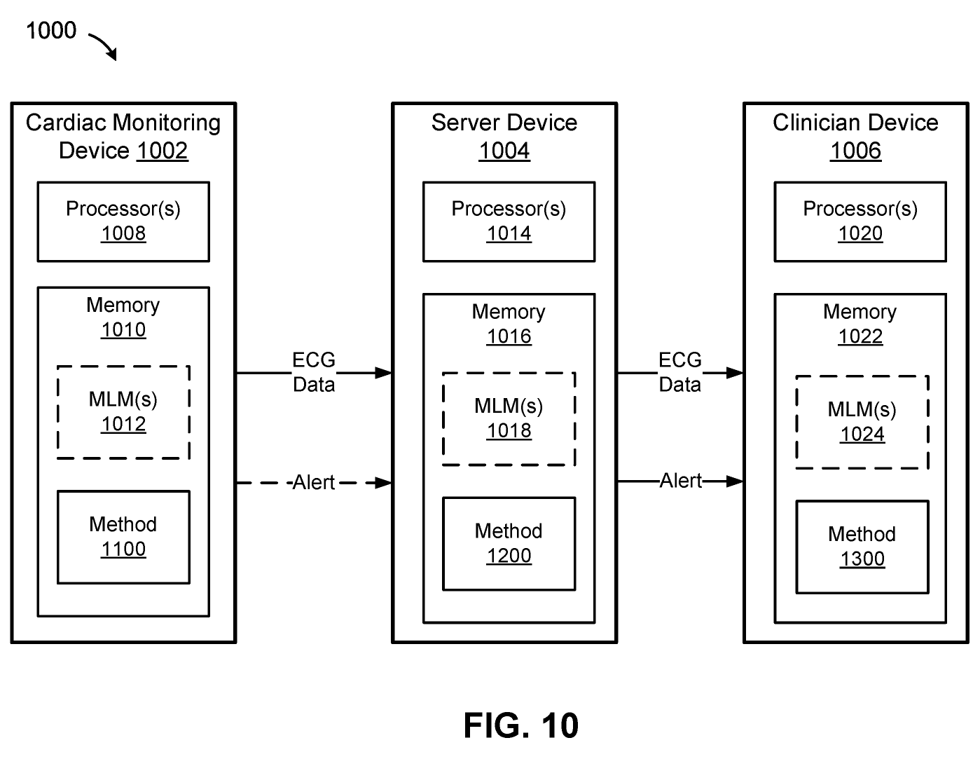

FIG. 10 illustrates a block diagram of an ACM system 1000 in accordance with one or more embodiments. ACM system 1000 may include an ACM device 1002, a server device 1004, and a clinician device 1006. ACM system 1000 may facilitate communication and data transfer between ACM device 1002, server device 1004, and clinician device 1006 to enable remote cardiac monitoring and clinical evaluation.

ACM device 1002 may be any of the ACM devices described herein, such as ACM device 100 depicted in FIG. 1, ACM device 100-1 and ACM device 100-2 depicted in FIG. 2, ACM device 500 depicted in FIG. 5, or ACM device 600 depicted in FIG. 6. ACM device 1002 may include one or more processors 1008 and memory 1010. Processor 1008 may be a microprocessor, a microcontroller, a low-power microcontroller unit, or the like. Memory 1010 may be random access memory (RAM), read-only memory (ROM), flash memory, or other computer-readable storage media. In some embodiments, memory 1010 stores one or more machine learning models (MLMs) 1012. MLM 1012 may correspond to MLM 712 described with reference to FIG. 7. In embodiments where ACM device 1002 includes MLM 1012, ACM device 1002 may classify data segments of the cardiac signals into one of a normal classification, an abnormal classification, or a corrupted classification, and may identify waveform characteristics that contributed to an abnormal classification. Memory 1010 may store instructions that, when executed by processor 1008, cause ACM device 1002 to perform the actions described in the blocks of method 1100. In some embodiments, the instructions cause ACM device 1002 to transmit cardiac signals or ECG data to server device 1004 via a wireless communication module. In embodiments where ACM device 1002 includes MLM 1012, the instructions may also cause ACM device 1002 to transmit an alert comprising an abnormal classification and identified waveform characteristics to server device 1004 or clinician device 1006.

Server device 1004 may be a remote computing device, such as a cloud-based server, a clinical data management platform, or other server infrastructure. Server device 1004 may include one or more processors 1014 and memory 1016. Memory 1016 may optionally store one or more machine learning models (MLMs) 1018. MLM 1018 may be used to classify data segments of the cardiac signals received from ACM device 1002 into one of a normal classification, an abnormal classification, or a corrupted classification. In some embodiments, server device 1004 performs classification of the cardiac signals when ACM device 1002 does not include an onboard MLM. In other embodiments, server device 1004 may perform its own classification of the cardiac signals in addition to or instead of classification performed by ACM device 1002. For data segments classified with the abnormal classification, MLM 1018 may identify a waveform characteristic of the data segment that contributed to the abnormal classification, such as irregular spacing between heartbeats, unexpected waveform segment durations, or atypical waveform peak amplitudes. Memory 1016 may store instructions that, when executed by processor 1014, cause server device 1004 to perform the actions described in the blocks of method 1200. In some embodiments, the instructions cause server device 1004 to transmit the cardiac signals, ECG data, classification results, and an alert comprising the abnormal classification and identified waveform characteristics to clinician device 1006.

Clinician device 1006 may be a remote computing device, such as user equipment (UE) 204 described with reference to FIG. 2. For example, clinician device 1006 may be a smartphone, a tablet, a laptop computer, a desktop computer, or other portable or stationary computing device operated by a medical provider. Clinician device 1006 may include one or more processors 1020 and memory 1022. Memory 1022 may store instructions that, when executed by processor 1020, cause clinician device 1006 to perform the actions described in the blocks of method 1300. In some embodiments, the instructions cause clinician device 1006 to receive cardiac signals, ECG data, classification results, and alerts from ACM device 1002 or server device 1004. Clinician device 1006 may display the received data and alerts to a clinician for review. In some embodiments, clinician device 1006 presents data segments classified with the abnormal classification along with the identified waveform characteristics that contributed to the abnormal classification, enabling the clinician to review the abnormal data and make clinical decisions regarding the subject's care. Clinician device 1006 may also display data segments classified with the normal classification or the corrupted classification, allowing the clinician to assess overall data quality and cardiac activity during the monitoring period.

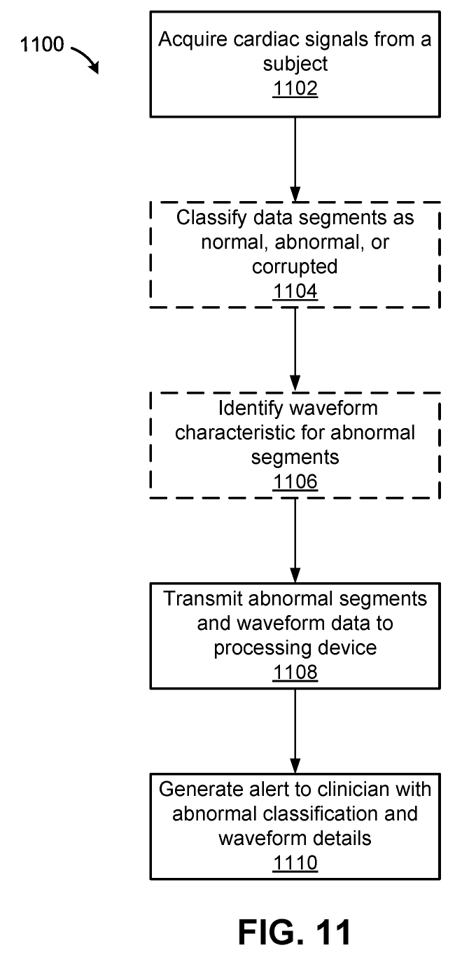

FIG. 11 illustrates a flow chart depicting a method 1100 for acquiring and processing cardiac signals from a subject with an ACM device, according to certain embodiments. Method 1100 may be performed by any of the ACM devices described herein, such as ACM device 100 depicted in FIG. 1, ACM device 100-1 and ACM device 100-2 depicted in FIG. 2, ACM device 500 depicted in FIG. 5, or ACM device 600 depicted in FIG. 6. Method 1100 may be performed by a processor executing instructions stored in memory, such as processor 702 and memory 710 described with reference to FIG. 7.

At block 1102, method 1100 may include acquiring cardiac signals from a subject via at least two sensing elements. The sensing elements may be conductive fabric electrodes embedded within one or more straps of a strap assembly worn by the subject. In some embodiments, the at least two sensing elements comprise three conductive fabric electrodes arranged to collectively acquire single-lead electrocardiogram (ECG) data. The sensing elements may continuously acquire cardiac signals while the subject performs daily activities, including walking, sitting, sleeping, or other movements typical of home or outpatient environments.

At block 1104, method 1100 may optionally include classifying data segments of the cardiac signals into one of a normal classification, an abnormal classification, or a corrupted classification. In some embodiments, the classification is performed using a machine learning model (MLM), such as MLM 712 described with reference to FIG. 7. The normal classification may be assigned to data segments where the cardiac signals exhibit characteristics consistent with healthy cardiac activity. The abnormal classification may be assigned to data segments where a waveform characteristic of the cardiac signals deviates from baseline cardiac activity. The corrupted classification may indicate that the data segment exhibits non-physiological characteristics, such as a flat line signal, high frequency noise exceeding a threshold power spectral density, or one or more abrupt signal discontinuities indicative of faulty electrode connection.

At block 1106, method 1100 may optionally include, for one or more data segments classified with the abnormal classification, identifying a waveform characteristic of the cardiac signals that contributed to the MLM assigning the abnormal classification. In some embodiments, the waveform characteristic is associated with at least one of a spacing between heartbeats, a duration of a waveform segment, or an amplitude of a waveform peak. For example, the identified waveform characteristic may include irregular spacing between heartbeats (e.g., variations in the R-R interval), unexpected waveform segment durations (e.g., prolonged QT intervals or widened QRS complexes), or atypical waveform peak amplitudes (e.g., elevated or depressed ST segments, inverted T-waves, or abnormal P-wave morphology). By identifying these specific waveform characteristics, method 1100 may provide clinicians with actionable information for further evaluation without rendering a diagnosis.

At block 1108, method 1100 may include transmitting the one or more data segments classified with the abnormal classification and the identified waveform characteristic to a processing device. In some embodiments, the transmission is performed using a wireless communication module, such as wireless communication module 704 described with reference to FIG. 7. The processing device may be a remote computing device, such as user equipment (UE) 204 described with reference to FIG. 2, or a server device, such as server device 1004 described with reference to FIG. 10. In some embodiments, the transmitted data is encrypted prior to transmission to protect patient privacy and comply with applicable data security requirements.

At block 1110, method 1100 may include causing at least one of the processing device or a remote computing device to generate an alert to at least one clinician. The alert may comprise at least the abnormal classification and the identified waveform characteristic for the one or more data segments. In some embodiments, the alert is transmitted to a clinician device, such as clinician device 1006 described with reference to FIG. 10, enabling the clinician to review the abnormal data and make clinical decisions regarding the subject's care. The alert may enable earlier detection of cardiac abnormalities and intervention before conditions worsen.

In some embodiments, method 1100 may further include labeling one or more peaks within the cardiac signals according to a correspondence of a respective peak of the one or more peaks to a component of an electrocardiogram (ECG) waveform. The component of the ECG waveform may comprise at least one of a P-wave, a Q-wave, an S-wave, or a T-wave. In certain embodiments, method 1100 may include quantizing each of the one or more labeled peaks and classifying the cardiac signals based at least on a combination of two or more of the quantized peaks.

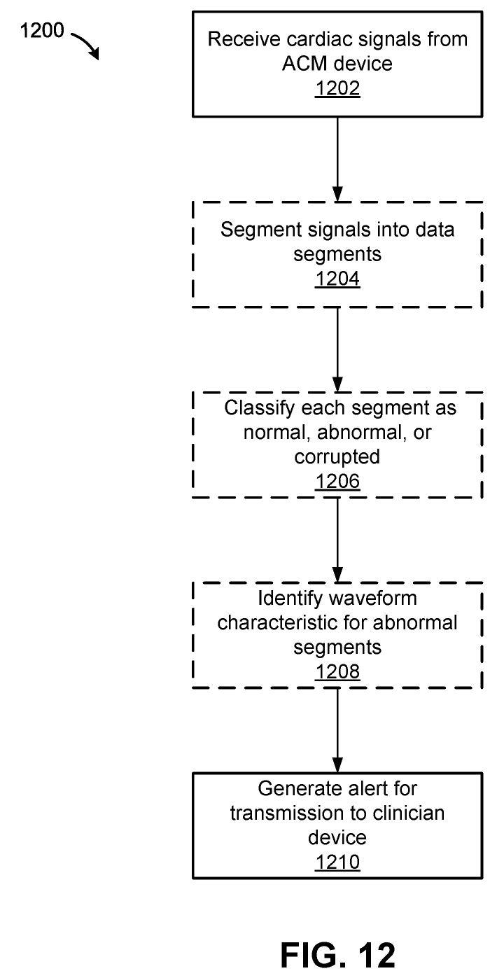

FIG. 12 illustrates a flow chart depicting a method 1200 for receiving and processing cardiac signals from an ACM device in accordance with one or more embodiments. Method 1200 may be performed by a server device, such as server device 1004 described with reference to FIG. 10. Method 1200 may be performed by one or more server processors executing instructions stored in server memory, such as processor 1014 and memory 1016 described with reference to FIG. 10.

At block 1202, method 1200 may include receiving cardiac signals from an ACM device via a wireless communication module. The ACM device may be any of the ACM devices described herein, such as ACM device 100 depicted in FIG. 1, ACM device 100-1 and ACM device 100-2 depicted in FIG. 2, ACM device 500 depicted in FIG. 5, or ACM device 600 depicted in FIG. 6. In some embodiments, the cardiac signals are received via a network, such as network 202 described with reference to FIG. 2. The received cardiac signals may be encrypted to protect patient privacy and comply with applicable data security requirements.

At block 1204, method 1200 may optionally include segmenting the received cardiac signals into a plurality of data segments. In some embodiments, each data segment corresponds to a predetermined time interval of cardiac activity. The segmentation may facilitate analysis of the cardiac signals by dividing the continuous signal into discrete portions that can be individually classified and evaluated.

At block 1206, method 1200 may optionally include classifying each data segment of the plurality of data segments into one of a normal classification, an abnormal classification, or a corrupted classification. In some embodiments, the classification is performed using a machine learning model (MLM), such as MLM 1018 described with reference to FIG. 10. The normal classification may be assigned to data segments where the cardiac signals exhibit characteristics consistent with healthy cardiac activity. The abnormal classification may be assigned to data segments where a waveform characteristic of the cardiac signals deviates from baseline cardiac activity. The corrupted classification may indicate that the data segment exhibits non-physiological characteristics, such as a flat line signal, high frequency noise exceeding a threshold power spectral density, or one or more abrupt signal discontinuities indicative of faulty electrode connection.

At block 1208, method 1200 may optionally include, for each data segment classified with the abnormal classification, identifying a waveform characteristic of the data segment that contributed to the abnormal classification. In some embodiments, the waveform characteristic is associated with at least one of a spacing between heartbeats, a duration of a waveform segment, or an amplitude of a waveform peak. For example, the identified waveform characteristic may include irregular spacing between heartbeats (e.g., variations in the R-R interval), unexpected waveform segment durations (e.g., prolonged QT intervals or widened QRS complexes), or atypical waveform peak amplitudes (e.g., elevated or depressed ST segments, inverted T-waves, or abnormal P-wave morphology). By identifying these specific waveform characteristics, method 1200 may provide clinicians with actionable information for further evaluation without rendering a diagnosis.

At block 1210, method 1200 may include generating an alert comprising the abnormal classification and the identified waveform characteristics for transmission to a clinician device. The clinician device may be a remote computing device, such as clinician device 1006 described with reference to FIG. 10. In some embodiments, the alert is transmitted to the clinician device via a network, such as network 202 described with reference to FIG. 2. The alert may enable earlier detection of cardiac abnormalities and intervention before conditions worsen. In some embodiments, the alert includes one or more data segments classified with the abnormal classification along with the identified waveform characteristics, enabling the clinician to review the abnormal data and make clinical decisions regarding the subject's care.

In some embodiments, method 1200 may further include storing the received cardiac signals, the classification results, and the identified waveform characteristics in a database or other data storage system. The stored data may be accessed by clinicians for subsequent review or may be used to generate reports summarizing the subject's cardiac activity during the monitoring period. In certain embodiments, method 1200 may include transmitting the cardiac signals, classification results, and alerts to multiple clinician devices or clinical data management platforms.

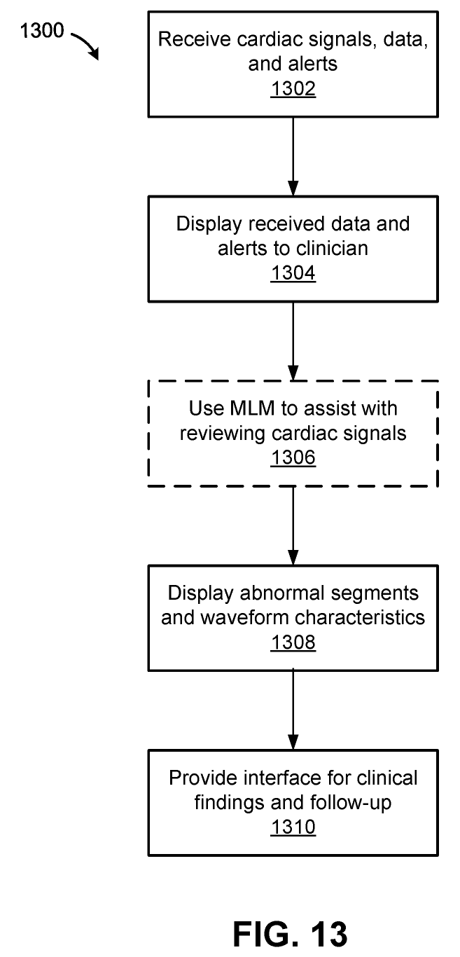

FIG. 13 illustrates a flow chart depicting a method 1300 for receiving and reviewing cardiac signals and alerts from an ACM device or server device in accordance with one or more embodiments. Method 1300 may be performed by a clinician device, such as clinician device 1006 described with reference to FIG. 10. Method 1300 may be performed by one or more processors executing instructions stored in memory, such as processor 1020 and memory 1022 described with reference to FIG. 10.

At block 1302, method 1300 may include receiving cardiac signals, ECG data, classification results, and alerts from an ACM device or a server device. The ACM device may be any of the ACM devices described herein, such as ACM device 100 depicted in FIG. 1, ACM device 100-1 and ACM device 100-2 depicted in FIG. 2, ACM device 500 depicted in FIG. 5, or ACM device 600 depicted in FIG. 6. The server device may be server device 1004 described with reference to FIG. 10. In some embodiments, the cardiac signals, ECG data, classification results, and alerts are received via a network, such as network 202 described with reference to FIG. 2. The received data may be encrypted to protect patient privacy and comply with applicable data security requirements.

At block 1304, method 1300 may include displaying the received data and alerts to a clinician. In some embodiments, the clinician device presents data segments classified with the abnormal classification along with the identified waveform characteristics that contributed to the abnormal classification. The clinician device may also display data segments classified with the normal classification or the corrupted classification, allowing the clinician to assess overall data quality and cardiac activity during the monitoring period. In certain embodiments, the clinician device may display the cardiac signals as a graphical waveform representation, enabling the clinician to visually inspect the ECG data.

At block 1306, method 1300 may optionally include using a machine learning model (MLM) to assist with reviewing the cardiac signals. In some embodiments, the MLM may highlight regions of interest within the cardiac signals, such as data segments that exhibit characteristics associated with potential arrhythmias or other cardiac abnormalities. The MLM may suggest potential diagnoses for clinician confirmation, without rendering a final diagnosis. In certain embodiments, the MLM may prioritize data segments for review based on a likelihood that the data segment contains clinically significant information, enabling the clinician to focus on the most relevant portions of the cardiac signals first. The MLM may also filter or sort the received data based on classification results, waveform characteristics, or other criteria specified by the clinician.

At block 1308, method 1300 may include displaying the abnormal data segments and identified waveform characteristics to the clinician. In some embodiments, the clinician device provides an interface that allows the clinician to navigate between data segments, zoom in on specific portions of the cardiac signals, annotate the data with clinical observations, or mark data segments for follow-up review. The identified waveform characteristics, such as irregular spacing between heartbeats, unexpected waveform segment durations, or atypical waveform peak amplitudes, may be displayed alongside the corresponding data segments to provide context for the clinician's review.

At block 1310, method 1300 may include providing an interface for documenting clinical findings, generating reports summarizing the subject's cardiac activity during the monitoring period, or initiating follow-up actions such as scheduling appointments, ordering additional tests, or adjusting treatment plans. Method 1300 may enable earlier detection of cardiac abnormalities and intervention before conditions worsen by providing the clinician with timely access to cardiac data and alerts.

In some embodiments, method 1300 may further include transmitting clinical findings, annotations, or instructions back to the ACM device or the server device. The transmitted information may be used to update the subject's medical record, adjust monitoring parameters, or provide feedback to improve the accuracy of machine learning models used for classification. In certain embodiments, method 1300 may include generating notifications to caregivers or the subject based on the clinician's review and clinical decisions.

In some embodiments, the methods, components, and features described herein are implemented by discrete hardware components or are integrated in the functionality of other hardware components such as ASICS, FPGAs, DSPs or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “identifying,” “receiving,” “causing,” “training,” “generating,” “providing,” “obtaining,” “interrupting,” “determining,” “transmitting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms "first," "second," "third," "fourth," etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein, or includes a general purpose computer system selectively programmed by a computer program stored in the computer system. Such a computer program is stored in a computer-readable tangible storage medium.

Some of the methods and illustrative examples described herein are not inherently related to any particular computer or other apparatus. In some embodiments, various general purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms "first," "second," "third," "fourth," etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ± 10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A device comprising:
at least two sensing elements to continuously acquire cardiac signals from a subject;
a wireless communication module;
a processor; and
memory storing a machine learning model (MLM) and instructions that, when executed by the processor, cause the device to:
classify data segments of the cardiac signals into one of: a normal classification, an abnormal classification, or a corrupted classification;
for one or more data segments classified with the abnormal classification, identify a waveform characteristic of the cardiac signals that contributed to the MLM assigning the abnormal classification;
transmit, using the wireless communication module, the one or more data segments classified with the abnormal classification and the identified waveform characteristic to a processing device; and
cause at least one of the processing device or a remote computing device to generate an alert to at least one clinician, wherein the alert comprises at least the abnormal classification and the identified waveform characteristic for the one or more data segments.

2. The device of claim 1, wherein the at least two sensing elements comprise three conductive fabric electrodes to acquire single-lead electrocardiogram (ECG) data.

3. The device of claim 1, wherein the waveform characteristic is associated with at least one of:
a spacing between heartbeats;
a duration of a waveform segment; or
an amplitude of a waveform peak.

4. The device of claim 1, wherein the instructions further cause the device to:
label one or more peaks within the cardiac signals according to a correspondence of a respective peak of the one or more peaks to a component of an electrocardiogram (ECG) waveform, wherein the component of the ECG waveform comprises at least one of a P-wave, a Q-wave, an S-wave, or a T-wave.

5. The device of claim 4, wherein the instructions further cause the device to:
quantize each of the one or more labeled peaks, and
classify the cardiac signals based at least on a combination of two or more of the quantized peaks.

6. The device of claim 1, wherein the corrupted classification indicates that the cardiac signals acquired from the subject exhibit non-physiological characteristics including at least one of: a flat line signal, high frequency noise exceeding a threshold power spectral density, or one or more abrupt signal discontinuities indicative of faulty electrode connection.

7. The device of claim 1, wherein the abnormal classification indicates that a waveform characteristic of the cardiac signals deviates from baseline cardiac activity.

8. The device of claim 1, further comprising a strap assembly comprising one or more straps, wherein the at least two sensing elements comprise conductive fabric electrodes embedded within the one or more straps.

9. The device of claim 8, further comprising:
a housing compartment to house the wireless communication module, the processor, and the memory, wherein the housing compartment is positioned within a fabric pocket integrated into a strap of the strap assembly, the fabric pocket configured to hold the housing compartment against the subject and reduce noise artifacts caused by movement of the housing compartment.

10. The device of claim 8, wherein the one or more straps of the strap assembly are adjustable to accommodate a range of body sizes using one or more of a hook-and-loop attachment, a button, a snap, a pin, or a clamp, and wherein the strap assembly is sized to accommodate a neonatal subject having a chest circumference between 6 inches and approximately 14.5 inches.

11. The device of claim 8, wherein the straps of the strap assembly comprise a hypoallergenic material.

12. A method comprising:
acquiring cardiac signals from a subject via at least two sensing elements;
classifying, using a machine learning model (MLM), data segments of the cardiac signals into one of: a normal classification, an abnormal classification, or a corrupted classification;
for one or more data segments classified with the abnormal classification, identifying a waveform characteristic of the cardiac signals that contributed to the MLM assigning the abnormal classification;
transmitting the one or more data segments classified with the abnormal classification and the identified waveform characteristic to a processing device; and
causing at least one of the processing device or a remote computing device to generate an alert to at least one clinician, wherein the alert comprises at least the abnormal classification and the identified waveform characteristic for the one or more data segments.

13. The method of claim 12, wherein the waveform characteristic is at least one of:
a spacing between heartbeats;
a duration of a waveform segment; or
an amplitude of a waveform peak.

14. The method of claim 12, further comprising:
labeling one or more peaks within the cardiac signals according to a correspondence of a respective peak of the one or more peaks to a component of an electrocardiogram (ECG) waveform, wherein the component of the ECG waveform comprises at least one of a P-wave, a Q-wave, an S-wave, or a T-wave.

15. The method of claim 14, further comprising:
quantizing each of the one or more labeled peaks; and
classifying the cardiac signals based at least on a combination of two or more of the quantized peaks.

16. The method of claim 12, wherein the corrupted classification indicates that the cardiac signals acquired from the subject exhibit non-physiological characteristics including at least one of: a flat line signal, high frequency noise exceeding a threshold power spectral density, or one or more abrupt signal discontinuities indicative of faulty electrode connection.

17. The method of claim 12, wherein the abnormal classification indicates that a waveform characteristic of the cardiac signals deviates from baseline cardiac activity.

18. The method of claim 12, wherein acquiring the cardiac signals comprises acquiring the cardiac signals via conductive fabric electrodes embedded within one or more straps of a strap assembly worn by the subject.

19. The method of claim 18, wherein a housing compartment housing a wireless communication module, a processor, and a memory is positioned within a fabric pocket integrated into the strap, the fabric pocket holding the housing compartment against the subject to reduce noise artifacts caused by movement of the housing compartment.

20. A system comprising:
a strap assembly comprising one or more straps, wherein at least two sensing elements are embedded within a strap of the strap assembly to acquire cardiac signals from a subject;
an electronics housing coupled to the strap assembly, the electronics housing comprising:
a processor;
a power source;
a wireless communication module; and
memory storing instructions that, when executed by the processor, cause the system to:
acquire the cardiac signals from the subject via the at least two sensing elements; and
transmit the cardiac signals to a remote processing server via the wireless communication module; and
a remote processing server comprising:
one or more server processors; and
a server memory storing a machine learning model (MLM) and instructions that, when executed by the one or more server processors, cause the remote processing server to:
receive the cardiac signals from the electronics housing;
segment the received cardiac signals into a plurality of data segments;
classify, using the MLM, each data segment of the plurality of data segments into one of a normal classification, an abnormal classification, or a corrupted classification;
for each data segment classified with the abnormal classification, identify a waveform characteristic of the data segment that contributed to the abnormal classification; and
generate an alert comprising the abnormal classification and the identified one or more waveform characteristics for transmission to a clinician device.
